(19) United States
(12) Patent Application Publication
(10) Pub. No.: US 2011/0193716 A1
(43) Pub. Date: Aug. 11, 2011

(54) Apparatus and Method for Providing an Audible Identification of the Contents of a Container

(75) Inventors: Jeffrey S. Goff, Murrysville, PA (US); Frederick W. Roberts, Sewickley, PA (US)

(73) Assignee: UPMC, Pittsburgh, PA (US)

(21) Appl. No.: 13/021,801

(22) Filed: Feb. 7, 2011

Related U.S. Application Data
(60) Provisional application No. 61/302,210, filed on Feb. 8, 2010.
(60) Provisional application No. 61/329,252, filed on Apr. 29, 2010.

(51) Int. Cl. G08B 3/00; G08B 21/22

(52) U.S. Cl. 340/686.6; 340/693.12; 340/540

(57) ABSTRACT

An apparatus includes a container and a content identification device providing an audible identification of the contents of the container. The container can be included in an automatic dispensing system. A method is also provided. The method includes providing a container, and producing an audible identification of contents of the container in response to one of: opening the container, a request to access the contents of the container, or actual access of the contents of the container by a user.

### CROSS-REFERENCE TO RELATED APPLICATIONS

This application claims the benefit of U.S. Provisional Patent Application No. 61/302,210, filed Feb. 8, 2010, and U.S. Provisional Patent Application No. 61/329,252, filed Apr. 29, 2010, both titled “Apparatus And Method For Providing An Audible Identification Of The Contents Of A Container”, which are hereby incorporated by reference.

### BACKGROUND OF THE INVENTION

1. Field of the Invention

The present invention relates to apparatus and methods for identifying the contents of containers.

2. Description of the Related Art

In a pharmacy, drugs may be stored in bins or other containers. To minimize the probability of dispensing errors, it is important that the drug retrieved from a bin matches the prescribed drug in both drug type and strength. Various techniques are known to identify the particular drugs within a container, for example, by using labels having the name of the drug thereon. Many drugs have similar names and may be available in different strengths. To differentiate drugs having similar names or different strengths, the labels may contain Tall Man lettering, distinctive fonts or letter size for different strengths, or the labels or containers may be color coded. Bins may have a lid, or may be open-topped. In any case, when a pharmacist, technician, nurse, or other authorized person retrieves drugs from a container, a visual cue is provided to identify the contents of the container.

It would be desirable to provide an improved apparatus and method for identifying the contents of a particular container.

### SUMMARY OF THE INVENTION

In a first aspect, the invention provides an apparatus including a container and a content identification device providing an audible identification of the contents of the container.

In another aspect, the invention provides an automatic dispensing system including a plurality of containers and a content identification means for providing an audible identification of the contents of the containers.

In another aspect, the invention provides a method including: providing a container, and producing an audible identification of contents of the container in response to one of: opening the container, a request to access the contents of the container, or actual access of the contents of the container by a user.

### BRIEF DESCRIPTION OF THE DRAWINGS

FIG. 1 is an isometric view of a container having an audio content identification device in accordance with an embodiment of the present invention.

FIG. 2 is a side view of the audio content identification device of FIG. 1.

FIG. 3 is a block diagram of the audio content identification device.

FIG. 4 is an isometric view of a system of containers of an embodiment of the present invention suited for densely populated implementations.

FIG. 5 is a block diagram of the audio content identification device suited for use in the embodiment of FIG. 4.

### DETAILED DESCRIPTION OF THE INVENTION

In various aspects, the present invention relates to an apparatus and method for identifying the contents of the containers. In one application, the invention can be used to identify the contents of the containers used to store drugs in a pharmacy. However, the invention is not limited to a particular application. The contents are identified using an audible message that can be customized, and therefore, can provide information such as warnings, safety reminders, inventory levels and reorder points, handling instructions, product expiration dates, or other such additional information, general or intrinsic, to the contents.

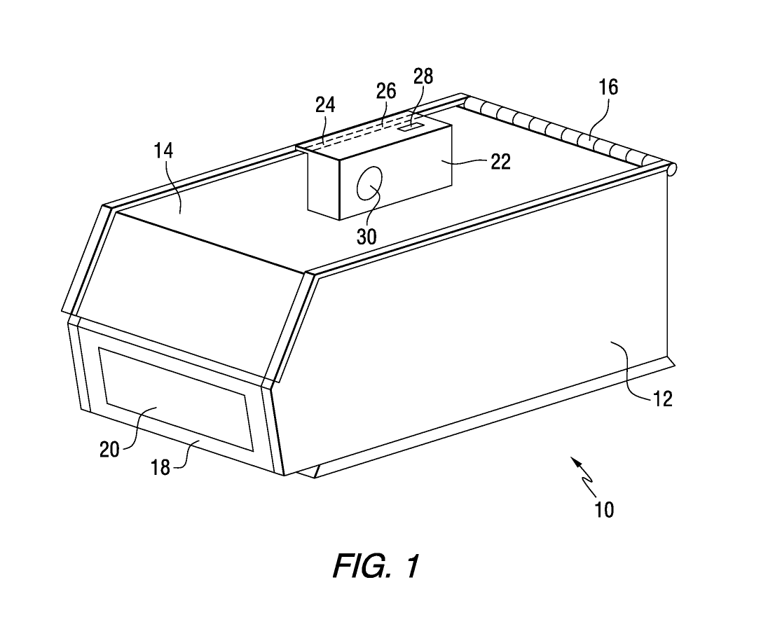

FIG. 1 is an isometric view of a container 10 in accordance with an embodiment of the present invention. The container includes a base portion 12 and a lid 14, which may be transparent, translucent or opaque. The lid is connected to the base by a hinge 16. The base includes a front face 18. A label 20, which identifies the contents of the container, may be attached to the front face 18. An audio content identification device 22 is mounted in the container. The audio content identification device is positioned adjacent to a wall of the base and includes one or more projections 24 that overlap a portion 26 of the edge of the wall of the container.

An activation means is provided to activate the audio content identification device when the lid is opened. Once activated, the device will announce the identity of the contents of the container, and may announce additional relevant information. In this example, a slot 28 is provided in the top of the audio content identification device for receiving an electrically insulating tab, not shown in this view. The electrically insulating tab can be inserted into the device to separate a pair of electrical contacts therein. When the lid is opened, the tab is extracted from the slot, allowing the pair of electrical contacts to touch, thereby activating the device. An audio processor within the device then drives a speaker 30 to announce the contents of the container.

Other activation means may be provided. For example, a micro switch may be incorporated into the top of the audio content identification device. When the lid is closed, it will depress the micro switch and deactivate the device. Alternatively, some form of proximity detector may be used to detect the presence of the lid adjacent to the audio content identification device. A light detecting photo cell is an example. In yet another embodiment, the audio content identification device may be activated in another manner, without requiring a lid or the movement of a lid. For example, a proximity sensor or capacitive sensor may be included that can detect the presence of a hand reaching into the container, and subsequently close a circuit that activates the device.

The audio content identification device may be a standalone component mated to a container or could be incorporated and built into the design of a specialized container.

Likewise, other containers besides bins may use audio announcements, including but not limited to storage cabinets, lockers, refrigerators, or automated dispensing cabinets.

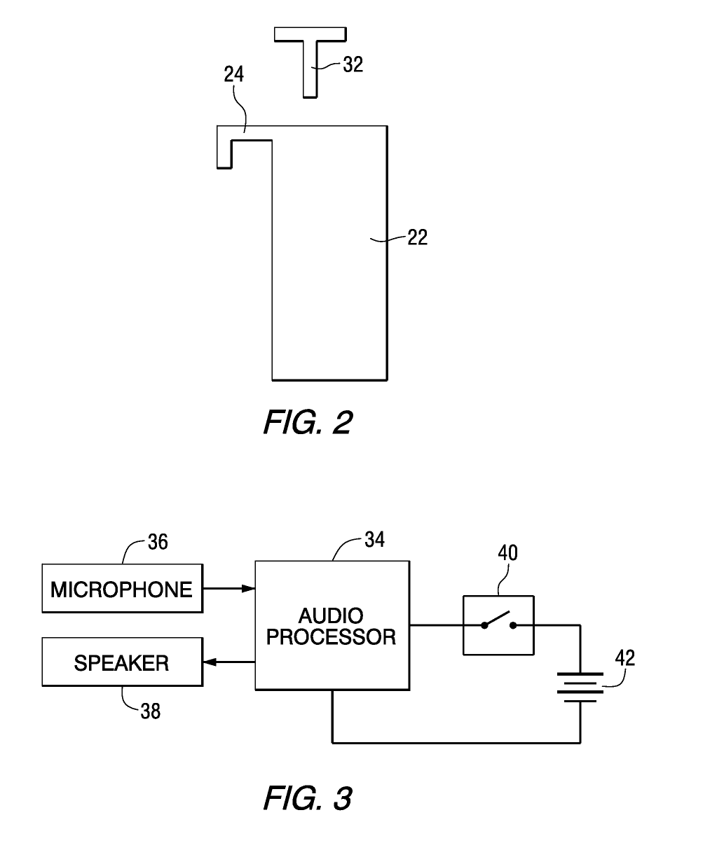

FIG. 2 is a side view of the audio content identification device 22. This view shows the projection 24 that is used to couple the audio content identification device to the edge of the base. A tab 32, which may be connected to the container lid, can be inserted in the slot on the top of the audio content identification device to separate a pair of contacts in the device, thereby deactivating the device.

FIG. 3 is a block diagram of the audio content identification device. The device includes an audio processor 34 that is connected to a microphone 36 and a speaker 38. In this example, a switch 40 serves as an activation means, which is used to connect or disconnect a battery 42. As described above, the switch can be activated by movement of the container lid or by some other activation means.

When the audio content identification device is to be mounted in the container, the microphone is used to input an audio message that will be stored in a memory associated with the audio processor. When the device is activated, the message will be played to inform a person accessing the container about the contents thereof. In other embodiments, the audio content identification device can include a pre-stored audio message. Messages could be recorded and stored elsewhere, and then played into the microphone, or transferred directly to the processor's memory. The audio processor could also be developed to store a library of messages to select from when configuring the device for use. The audio processor could be a device that is connected to and managed by a computer, either directly or over a network, where the host computer could load or unload messages, set configurations, or other such management tasks.

In one example, the audio content may include the name of the drug to be stored in the container, along with the strength and other relevant information. In another example, the audio content identification device may gather information about the contents of the container from the content packaging. For example, the contents may include a radio frequency identification device (RFID), which is used to supply information to the audio content identification device. The audio content identification device can include RFID reading circuitry. Then the audio content identification device can generate the audio signal in response to information received from the RFID.

The audio content identification information can be used in combination with a label on the container, thus providing a user with both visual and auditory verification of the container contents.

While the invention is useful for containers that include drugs as described above, it is also useful in other applications. For example, in any case where a vision impaired person wishes to retrieve items from a container, or a vision-capable person under circumstances where vision is reduced, the audio content identification device can provide an audio indication of the container contents when the container is opened, or otherwise accessed if the embodiment does not include a lid. The invention may also be useful when the contents of the container are not readily recognizable.

Another embodiment of the invention could include one or more audio content identification devices in an environment where there are many containers within a small space. In this particular embodiment, an audio processor could store many messages and serve as a centralized component, with an activation device for each container. When a container's activation device is triggered, the central audio processor plays the message assigned to that activation device.

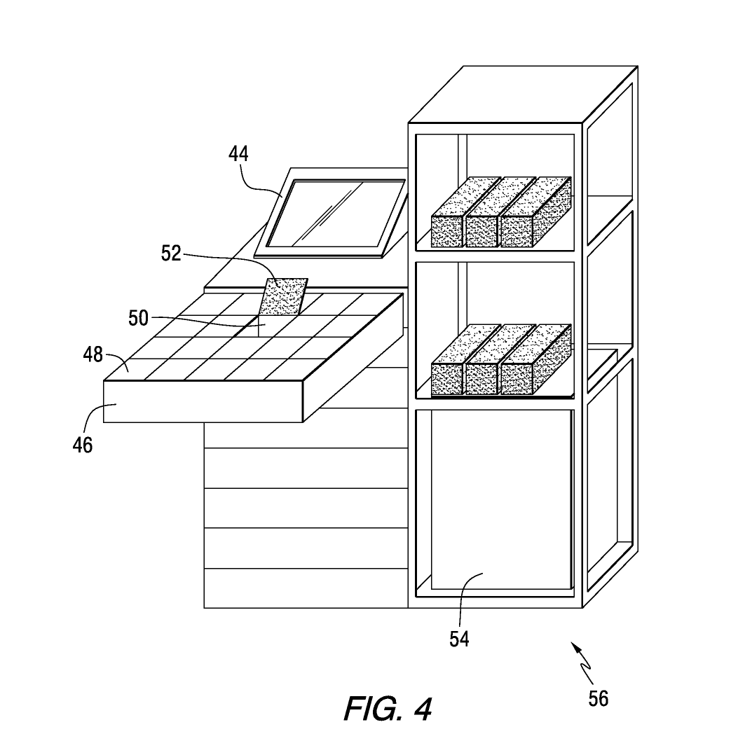

FIG. 4 is an isometric view of an automated dispensing machine 56 which houses one or more drawers 46 with containers 48 within each drawer. Such a machine may incorporate controls for accessing the containers via a human-to-computer interface 44. When a person opens or otherwise gains access to a specific drawer and/or a specific container, for example via a user interface, an audio message will be triggered, revealing the contents of the container 50. The audio message can be triggered using any of the means described herein, such as through the activation of a switch or sensor, or by software in a controller of an automatic dispensing system. Alternatively, a drawer could be considered to be a single container.

In one aspect, the invention can be implemented using existing automated dispensing systems. Such systems may include the components of a standard desktop computer, including a motherboard, RAM, processor, disk drive, peripheral cards for printing, serial connections, USB connections, keyboard, touch screen, Ethernet, and speaker. Peripheral card(s) may be included for managing drawers in a cabinet, and in the case of special drawers, individual containers or pockets that contain medications. In one example, the operation of the system is controlled by proprietary software that stores information in a database, runs on top of an operating system using well-known hardware. The system may run continuously, processing data between hardware, the user and the database, and between itself and other stations on a network.

The containers (also called pockets) can be uniquely identified via an internal circuit board, with electrical contacts on the bottom, plus moving parts for opening the lid. Pockets come in various sizes. The smallest pocket might be referred to as a Unit. A larger pocket may be one unit long and three units wide. A drawer may include, for example, 48 Units. A person setting up the automated dispensing system can arrange the special drawers as needed. The pockets can snap into place in the drawer bottom, with their electrical contacts touching a strip for power and communications. When the parts are snapped into place and the system is turned on, the computer will detect or “see” those pockets by virtue of their uniquely identifiable circuit boards. Other automated dispensing machines may have fixed pockets which cannot be removed, but those pockets can still be uniquely identified by the host computer.

A person setting up the system can define via the software what drugs will go into what pocket.

Should a pocket, or drawer containing many pockets, fail for some reason, it can be removed from the system, and another put in its place. Since the replacement would have a new and different unique identifier(s), a person setting it up may have to redefine what drugs will go in that pocket or drawer.

The invention can be implemented using various known types of hardware, operating systems, and/or databases. Existing automated dispensing systems include components that can be configured to implement the invention. That is, such systems include computer hardware capable of playing sound files and a database of pockets and their properties. To produce one embodiment of the invention, a step can be added to the set-up process. The person making the drug assignment to the pocket can choose a sound file or message to play when the pocket is opened or accessed.

The software that operates the system can be modified, such that when it receives a request to open a particular pocket, in addition to opening the lid, the software can identify a sound X stored in the system at a location Y, and render the sound file via an application program interface call to the operating system. Then the audio message can be played through the system speaker. Thus, the audio message is played when a pocket lid is opened.

In another embodiment, that audio signal can be a customized message, which may be created by recording live air, or may be synthesized using a speech synthesizer driven from other content. For example, if a database record contains the name of a drug or its National Drug Code (NDC), the audio message could be the speech synthesizer's rendering of that text, or text relating to it. Such an implementation offers some advantages including: 1) data integrity, and 2) administrative efficiencies. Data integrity is achieved through a linear transformation of data from one form (text) to another (sound), whereas an audio recording must be heard and compared to text to verify its accuracy. Administrative efficiency is achieved in that no additional administrative burden is needed to implement the audio massages, as they are derived and not created.

In other embodiments, the system can include software tools for managing a sound library, including functions for listing, recording, editing, and deleting of messages. In addition, metadata can be included in the messages. This metadata can be used to produce reports including, for example, a creation date, modified date, creator, message duration, etc. Protections can be imposed on messages that are assigned to the pockets to prevent tampering. Such protections may include locking a message, identification of authorized users, etc. In addition, the audio messages can be included as part of the system's overall audit trail. An interface can be included for bulk loading or importing of the messages during system setup. This would allow the operator to use other platforms for message creation. Software tools can also be included for managing voices and voice properties of a speech synthesizer.

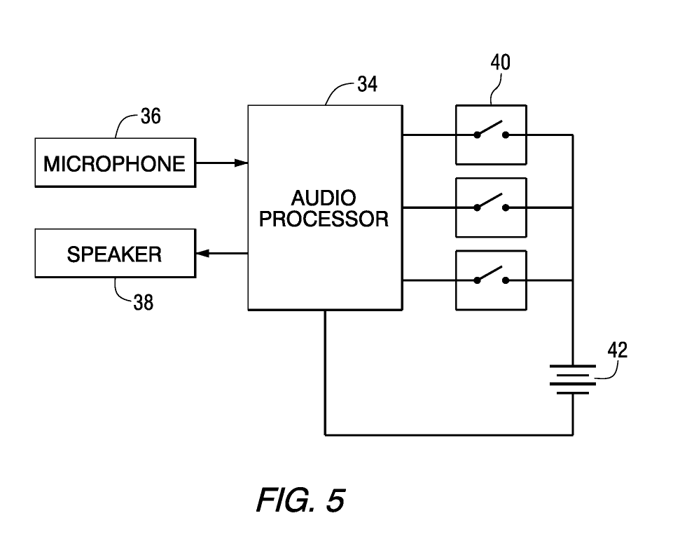

FIG. 5 is a block diagram of the audio content identification device where the audio processor 34 can store one or more audio messages, and those messages can be assigned to one, some, all, or none of the activation devices shown as 40. This architecture allows for the consolidation of supplied power, speaker(s), the audio processor itself, and then merely replicates the activation device 40 for each container within a densely populated concentration.

In another aspect, the invention provides a method of identifying the contents of a container that can be implemented using the devices described above. For example, the method may include: providing a container, and producing an audible identification of contents of the container in response to one of: opening or accessing the container, a request to access the contents of the container, or actual access of the contents of the container by a user.

The request to access the container may be provided by a user of an automatic dispensing system, for example by way of a user interface. Actual access of the contents may be for example when a user reaches into the container and a sensor detects the user's hand and activates an audio content identification device.

While the invention has been described in terms of several embodiments, it will be apparent to those skilled in the art that various changes can be made to the described embodiments without departing from the scope of the invention as set forth in the following claims.

What is claimed is:

1. An apparatus comprising:
a container; and
a content identification device providing an audible identification of the contents of the container.

2. The apparatus of claim 1, where in the container includes a lid, and the content identification device provides the audible identification of the contents of the container in response to opening of the lid.

3. The apparatus of claim 1, wherein the content identification device provides additional audible information relating to the contents of the container.

4. The apparatus of claim 3, wherein the additional audible information includes one or more of: a warning, a safety reminder, an inventory level, handling instructions, or an expiration date.

5. The apparatus of claim 1, further comprising:
a switch, or a proximity detector for causing the content identification device to emit the audible information.

6. The apparatus of claim 1, wherein the container comprises one of:
a bin, cabinet, locker, refrigerator, or automated dispensing cabinet.

7. The apparatus of claim 1, wherein the content identification device includes an audio processor and a microphone for recording messages on the audio processor.

8. The apparatus of claim 1, wherein the content identification device includes an audio processor connected to a network.

9. The apparatus of claim 1, wherein the content identification device receives content information from a radio frequency identification device.

10. An apparatus comprising:
an automatic dispensing system including a plurality of containers; and
a content identification means for providing an audible identification of the contents of the containers.

11. The apparatus of claim 10, wherein the content identification means comprises:
a sound file or message.

12. The apparatus of claim 10, further comprising:
an activation means for causing the content identification means to emit the audible information.

13. The apparatus of claim 12, wherein the activation means responds to a request for access to one of the containers.

14. The apparatus of claim 12, wherein the activation means responds to an opening of one of the containers.

15. The apparatus of claim 10, wherein the content identification means comprises:
a synthesized speech rendering of the contents of one of the containers.

16. The apparatus of claim 10, wherein the content identification device provides additional audible information relating to the contents of the pockets.

17. The apparatus of claim 16, wherein the additional audible information includes one or more of: a warning, a safety reminder, an inventory level, handling instructions, or an expiration date.

18. The apparatus of claim 10, wherein the content identification means includes an audio processor and a microphone for recording messages on the audio processor.

19. The apparatus of claim 10, wherein the content identification means receives content information from a radio frequency identification device.

20. A method comprising:
providing a container; and
producing an audible identification of contents of the container in response to one of: opening the container, a request to access the contents of the container, or actual access of the contents of the container by a user.
